(19) United States
(12) Patent Application Publication
(10) Pub. No.: US 2005/0288009 A1
(43) Pub. Date: Dec. 29, 2005

(54) Method and apparatus for objective measurement of wireless service performance and coverage

(76) Inventor: Mark Poletti, Louisville, CO (US)

Correspondence Address: Mark Poletti, 913 W. Alder St., Louisville, CO, 80027, US

(21) Appl. No.: 10/877,183

(22) Filed: Jun. 28, 2004

(51) Int. Cl. H04Q 7/20

(52) U.S. Cl. 455/423

(57) ABSTRACT

The purpose of this invention is to provide a small, low-cost, modular unit which can be used for automated wireless network benchmarking and data collection. This invention provides a method to conduct simultaneous performance measurements on wireless networks that use multiple air interface technologies in multiple frequency bands. The invention will be capable of placing calls on wireless networks and recording typical diagnostic measurements and performance data, along with position information, without the use of a traditional wireless phone and data collection vehicle. This information is routinely used by service providers and other customers to identify performance problem areas, roaming issues and competitive benchmarking. One method for downloading performance data will be over a stand-alone 802.11x network at a predetermined location at the end of the drive-test period to a simple server and storage unit where it can be accessed for analysis. Alternatively, data transfer may also be achieved by using removable data storage media such as flash memory. The invention will be capable of receiving new customized phone software loads and dialing patterns using the same 802.11x network. Potential applications are in taxis, buses and other fleet vehicles which give random or repeatable routes, eliminating the expense of drive-testers and drive-test vehicles. This provides the ability to customize market drive routes, to provide more detailed and timely performance data in terms of area and time of day. Potential customers include wireless service providers, wireless resellers, engineering contracting/consulting firms, third party bench-marking companies, local municipalities and planning commissions.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention is applicable to wireless communications, geo-location and telemetry networks, such as Multipoint Multi-service Distribution System (MMDS), 802.11x (wireless local area networks), cellular, Personal Communication Service (PCS) and Enhanced Specialized Mobile Radio (ESMR) wireless services. Wireless service provides full-duplex voice and data communications to the wireless user and the public internet using a mobile phone in a fixed, portable or mobile environment.

### BACKGROUND OF THE INVENTION

Cellular service is provided by up to two service providers in one of two frequency bands, A or B, in the 824 to 894 MHz band. In the US, market boundaries are defined by Metropolitan Service Areas (MSA) or Rural Service Areas (RSA).

PCS service is provided by up to six service providers in one of six frequency bands, A to F, in the 1850 to 1990 MHz band. In the US, market boundaries are defined by Rand McNally's Major Trading Areas (MTA) or Basic Trading Areas (BTA).

Service Operators design objectives for network performance are a combination of coverage area, access and drop call statistics. Typically, coverage is designed for 90% probability of service, and access failures and drop call rates are targeted at 2%.

Currently, under-performing areas in a network are identified either through customer trouble tickets, engineering drive tests or error logging at the network switch. These methods are limited and reactive, relying on already upset customers to report location and event information, and engineers who rely on extensive, time intensive drive tests and error log analysis to find problems. The end result of these processes is an inefficient allocation of engineering effort and capital allocation to fix trouble areas, and an unfulfilled customer experience which increases the likelihood of churn.

While service operators drive their overall network to the network performance objectives described above, individual subscribers may experience a lesser level of service. Additionally, these metrics are applied on a network wide basis, without regard for competitive advantage or disadvantage in particular areas, such as downtown, bedroom communities or highways. The individual experience of network quality is one of the leading drivers of churn. Thus, the operator has the additional task of searching for trouble areas, then resolving the issue through system optimization or new site builds.

For example, consider a customer who works downtown and lives in the suburbs, using an operator which has 2% drop calls and 2% access failures in all areas. This customer may be perfectly happy with the performance in his home area, but when he is downtown in a work environment, he is more likely to be unhappy with a drop or failed call. The service provider sees only that performance objectives are met, and may not react to complaints from this customer, if he even bothers to call in a problem. If other providers have better performance in this area, he will likely churn.

The invention solves the problem with a method and tool to regularly, automatically and proactively measure both the performance of the operator's network, as well as the competition's network in these areas. It eliminates the need for dedicated drive testers and drive test vehicles owned by the operator, reducing expense and capital. This invention also allows users other than service operators, such as public safety organizations, planning and zoning commissions, benchmarking companies and business development groups the ability to obtain specific, detailed network performance data.

Current commercially available engineering design and measurement tools utilize multiple apparatus and various interfaces to measure wireless service performance requiring unique skills, experience, and training. Typical measurement tool configurations include multiple wireless handsets, a vendor proprietary data cable, a personal computer, an operating system, and proprietary application software; all of which resides in a drive test vehicle that is driven by the service provider's engineers or technicians in order to collect data. Performance data transfer is typically achieved by direct data cable transfer or transfer over the internal local area network/wide area network (LAN/WAN) information technology (IT) network. Such measurement tools are created for engineering teams within service operator organizations, and only measure performance of one network.

Some wireless providers use internally-owned benchmarking measurement tools to measure their own coverage and performance against competitor's coverage and performance. Similar to engineering design and measurement tools, these tools are comprised of multiple apparatus and various interfaces to measure wireless service performance requiring unique skills, experience, and training. These solutions also typically reside in a drive test vehicle that is operated by the service provider's engineers or technicians. Internal engineering teams conduct measurements and generate analysis of market service coverage and performance, which is a man-power and time intensive task. Additionally, installation and set-up in the test vehicle is cumbersome and requires particular sensitivity to isolating multiple wireless mobile antennas. These measurements are limited in time and scope, usually once per quarter with one pass through each area, missing any time-of-day effects and only driving major highways and roads.

Wireless companies exist that provide competitive benchmarking measurement and evaluation service that compares the service coverage and performance of multiple wireless providers in a particular market. However, this requires hiring the company for the service which includes the measurement tools, engineering team, drive-test vehicles, and time to conduct the measurements and analysis. Again, this benchmarking is limited in time and scope.

Remote, unmanned data collection tools exist that can be deployed in fleet type vehicles. These existing remote solutions rely on having several subscriber handsets with proprietary data cables residing on board the remote device. Data transfer is achieved via use of an on board data modem that transmits the data over a cellular or PCS carriers wireless data network. These solutions help eliminate the need for manned drive testing. However, they still rely on using subscriber handsets which require proprietary data cables and advanced intelligent network (AIN) interfaces. In addition, they attempt to transfer collected data over the carrier's wireless data network which is costly since it uses valuable network resources and capacity. It can also impact the carrier's network quality up to and including, causing false network impairment collection results due to simultaneous data transfer and data collection on the network.

### BACKGROUND OF THE INVENTION—ADVANTAGES

This invention has the following advantages:
(a) Provides simultaneous comparison of wireless service performance of multiple service providers.
(b) Provides easy integration into fleet vehicles
(c) Provides regular, detailed system performance information at all times of the day, as opposed to quarterly, one-pass data
(d) Provides the ability for random or regular drive routes through fleet vehicle selection; e.g. taxis vs. buses
(e) Uses an independent network, such as wireless data networks, 802.11x networks, and voice networks for performance data download, freeing up operator resources
(f) Uses an independent network, such as wireless data networks, 802.11x networks, and voice networks to receive customized phone software loads, dialing patterns and other information or data.
(g) Eliminates the need for dedicated drive test vehicles and drive testers through automated call testing.
(h) Uses alternative solutions to subscriber handsets for placing calls and collecting data, thus eliminating the dependency on proprietary interfaces and to reduce size, cost, and power consumption.

### SUMMARY OF INVENTION

An apparatus actively measures and collects performance data (such as: Receive Signal Strength Indicator (RSSI), Signal to Noise Ratio (S/N), Frame Error Rate (FER), drop call and access failure locations) from multiple wireless networks for a period of time based on pre-programmed, self controlling algorithms. Measurement and data collection may be performed simultaneously, sequentially, or use similar such techniques on multiple service provider networks using multiple air interface technologies and multiple frequency bands. Data is then transferred to a central location of analysis and reporting via a wireless Institute of Electrical and Electronic Engineer (IEEE) standard 802.11x network or via collection of removable data storage media.

The apparatus works in the following situations:
(a) Any market where Cellular, Personal Communication Service (PCS), ESMR or other wireless service, such as Multi-service Multi-point Distribution Service (MMDS) or 802.11, is available.
(b) Any wireless air interface technology, such as: Advanced Mobile Phone Service (AMPS), Code Division Multiple Access (CDMA), Time Division Multiple Access (TDMA), Global System for Mobile Communications (GSM), Enhanced Specialized Mobile Radio (ESMR), Integrated Dispatched Enhanced Networks (iDEN), and Universal Mobile Telecommunications System (UMTS) or other wireless air interfaces.
(c) Multiple frequency bands, e.g. Cellular at 824 to 894 MHz and PCS at 1850 to 1990 MHz, or other bands
(d) A multiplicity of locations, including mobile, in-vehicle environments
(e) Any weather conditions, such as rain, sunshine, snow and sleet
(f) Wide range of operating temperatures; e.g. −10 F to +130 F
(g) Wide range of humidity; e.g. 0 to 100%

### GENERAL DESCRIPTION OF DRAWINGS

FIG. 1. is a schematic representation of the invention and offers an example design solution with an efficient and cost effective approach.

FIG. 2 is a diagram representing an optional design using a baseband modem chip.

FIG. 3 is a diagram representing an optional design using a personal computer memory card international association (PCMCIA) card.

### DETAILED DESCRIPTION OF DRAWINGS

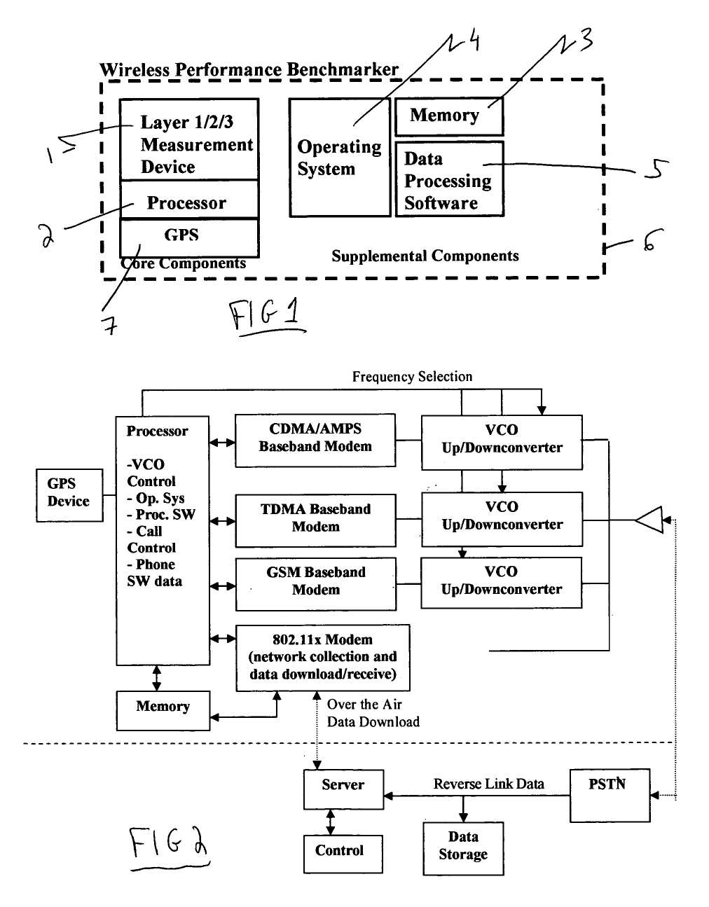

The essential elements of the invention are shown in FIG. 1 which consists of a Layer 1/Layer 2/Layer 3 Measurement Device 1 which acts as the Radio Frequency (RF) (Layer 1) interface, the air-interface technology (CDMA, GSM, TDMA, AMPS) demodulator, Layer 2 messaging interface and measurement tool, and Layer 3 network interface messaging.

A Processor, such as a Central Processing Unit (CPU), 2 is the main engine of the apparatus. The processor is responsible for controlling the Layer 1, Layer 2 and Layer 3 data messaging in the measurement device as well as processing data collection.

Memory 3, (such as removable solid state), is required to store collected data from the measurement device as well as network identification information. The memory can be removed to transfer data and will be solid state (i.e. compact flash).

The Operating System 4 manages complete operation of the device.

The Data Processing Method 5, such as those embodied in software or firmware, will reside on the processor and will perform calculations on the collected data to determine results of the measurement session. Examples of these are complex diagnostic monitoring tools which have the ability to process messaging as well as signal information, or basic signal processing software.

The entire apparatus will be in a compact enclosure 6 and will be provided to the user in the form of a single unit.

A Global Positioning System (GPS) Device 7, a measurement device indicating the location of events, such as drop calls, access failures or poor quality as evidenced by high FER will be included in the apparatus.

The apparatus will also have the following elements:
(a) Portable enclosure: A portable enclosure will be provided to the user allowing for portable transportation of the unit.
(b) Multiple power options: Multiple power options (such as battery, a/c power, d/c power, car adapter, rechargeable battery) will be used as part of the design enabling the user the ability to use the unit in multiple locations.
(c) A standard user device (such as 802.11x Network Interface card): The standard user device enables data collection of 802.11x networks as well as unmanned wireless data transfer of collected measurement data.

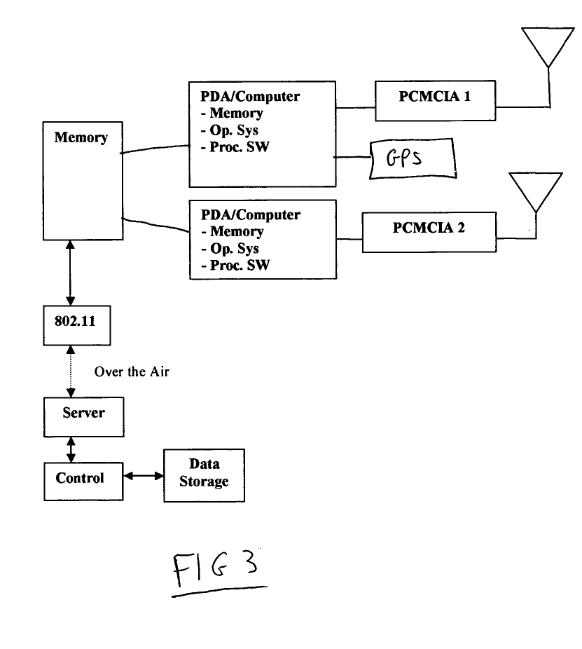

FIG. 2 shows one example of the invention. Additional chips or modems can be used for other wireless air interface technologies. In this example, the 802.11x modem serves a dual function. It collects data on available 802.11x networks, similar to the other baseband modems, as well as performing over the air data download and software programming. Other designs which use combinations of these options or alternative designs are possible.

FIG. 3 shows another example of the invention. In this option, the 802.11x modem could be one of the PCMCIA cards and perform dual tasks as the FIG. 2 design option, or a stand-alone 802.11x chip dedicated to data download and unit programming.

The cost of the invention is anticipated to be less than the competition because the invention uses a subset of actual phone design components and software, eliminating things such as chassis, keypad, display, user interface and feature software, e.g. 3-way calling and call forwarding. Additionally, the need for a dedicated test vehicle and driver will be eliminated. In addition, the cost of proprietary physical (data cables) and logical (AIN) interfaces will be eliminated.

The size and installation of this invention will be small and efficient. In comparison to competitive systems, the invention will be the size of a laptop, with a “plug and play” installation into the vehicle.

This invention will save user's expense and capacity on existing networks. Data will be stored in the invention for transfer via an 802.11 x wireless network at pre-determined times, or by removal of compact memory media. The invention will not use existing subscriber data networks as some current applications do.

The invention is programmable and will be able to accept mobile Preferred Roaming Lists (PRL), phone software version updates and dialing instructions via the same 802.11x system which is used for data downloading. Existing solutions' mobiles must be programmed via a data cable individually, either at a store or by the technician or engineer.

The invention will be designed to provide sufficient isolation between frequencies and technologies internally, resulting in a simpler, easier installable design. Alternative installations use either cumbersome cabling to the mobile Radio frequency (RF) port, or actual mobile antennas which cause isolation and interference concerns within the vehicle.

Multiple power options (such as battery, a/c power, d/c power, car adapter, rechargeable battery) will be used as part of the design enabling the user the ability to use the unit in multiple locations.

1. The invention's modular design will allow for flexible deployment of a multiplicity of test phones, which could be from an individual provider or multiple providers.

2. This invention can take simultaneous measurements of multiple service providers using multiple frequency bands (e.g. cellular and PCS).

3. Design approaches, such as a base-band modem chipset or PCMCIA card, may be used as an alternative solution to wireless handsets. This allows for a compact and light-weight design by eliminating the need for a proprietary interface cable from the handset to a personal computer. This not only enhances the compact and light-weight design characteristics, but it also enhances the data collection and processing ability ultimately improving overall measurement time and efficiency. Since no two handsets are alike, eliminating the handset as part of the solution also provides for a more representative measurement of parameters used for service performance, such as RSSI, S/N, Ec/Io, dropped calls, access failures and poor quality.
